(19) United States
(12) Patent Application Publication
(10) Pub. No.: US 2007/0136100 A1
(43) Pub. Date: Jun. 14, 2007

(54) SYSTEMS AND METHODS FOR ACCELERATED PAYMENT OF PHARMACY PRESCRIPTION CLAIMS

(76) Inventors: Loraine Daugherty, Park City, UT (US); Adam Condie, Salt Lake City, UT (US)

Correspondence Address: MORRISS O''BRYANT COMPAGNI, P.C., 734 EAST 200 SOUTH, SALT LAKE CITY, UT, 84102, US

(21) Appl. No.: 11/467,347

(22) Filed: Aug. 25, 2006

Related U.S. Application Data
(60) Provisional application No. 60/711,948, filed on Aug. 26, 2005.

(51) Int. Cl. G06F 19/00; G06Q 40/00

(52) U.S. Cl. 705/3; 705/4; 705/39

(57) ABSTRACT

Methods and systems are related to the payment of pharmacy benefits under an insurance policy. The system includes pharmacies, a real-time claims processing adjudication component, an information component and a claims processing or billing component. When a qualified patient submits a prescription to a participating pharmacy, the pharmacy collects identifying information from the patient and conveys a request to the real-time claims adjudication component, which screens the request for a match to data already loaded in the system and conveys a notification of acceptance or error to the pharmacy. The real-time claims adjudication component compiles records of the approved claims and the claims processing component processes the claims, bills third party payors and generates periodic files detailing payments owed to pharmacies. Funds are then made available to the pharmacy. The pharmacy may obtain the funds by initiating a transfer, such as a charge placed on a card issued by the system.

### CROSS-REFERENCE TO RELATED APPLICATION

The present invention claims priority to U.S. Provisional Patent Application Ser. No. 60/711,948 filed on Aug. 26, 2005, which is hereby incorporated herein in its entirety.

### TECHNICAL FIELD

The present invention relates generally to systems and methods for providing and paying for health care items. More particularly, the present invention relates to systems and methods for providing pharmaceutical and health care items to customers and participating retailers in a way that provides accelerated third-party payment to the retailers.

### BACKGROUND OF THE INVENTION

In order to obtain prescribed medical items, customers present a prescription for a pharmaceutical or other medical good (such as crutches or syringes) to a pharmacist at a retailer. The item is then provided to the customer and payment is collected. Payment has been traditionally collected either directly from the patient at the time of delivery or from a third-party payor such as an insurance company. In order to receive payment from the third party payor, pharmacies must submit a claim containing all the required information and then wait until the claim is approved by the third party payor and payment made on the payor's predetermined schedule. Where a pharmacy requires the customer to pay for the entire amount of the purchase upon delivery, the customer must submit the claim to their insurer and then wait for reimbursement.

This has placed the pharmacies in the position of either having to inconvenience customers by requiring payment upfront, and potentially lose business to their competitors who do not require their customers to wait for reimbursements, or to wait a typical minimum of 45 to 90 days for payment from insurers. Further, in order to decrease costs, many insurers and other third-party payors have turned to prescription benefit managers (PBMs) to handle the administrative functions of providing prescription benefits to their policyholders. Any errors in the submission or handling of a claim, whether at the pharmacy, the PBM or the insurer can thus delay payment even longer. Where the customers utilize a third-party payor other than their usual insurer, such as those customers making a claim on a worker's compensation policy, the cycle may be even further delayed.

Attempts have been made to find ways to shorten this payment cycle. For example, U.S. Patent Application US 2002/0128863, entitled Method and System for Providing Prescription Drug Coverage, the disclosure of which is incorporated herein in its entirety, discloses a system using a prescription benefit card provided to an insured. When the insured presents a prescription and the card at a merchant, the merchant sends a payment request by swiping the card, and a payment is deducted from an account associated with the card issuer. While this system can provide for faster payment, it is limited to individuals issued cards by a payor and it does not allow for participation by individuals not already receiving a card or for the examination and adjudication of claims on an expedited basis.

A system or method of allowing customers to obtain prescription benefits with an accelerated payment from a third party payor that allows for participation by customers who may only need to utilize that payor a limited number of times would be an improvement in the art. Such a method or system that also allows for expedited adjudication of insurance claims would similarly constitute an improvement in the art.

### SUMMARY OF THE INVENTION

The present invention includes methods and systems related to the payment of pharmacy benefits under an insurance policy, and more specifically under worker's compensation policies. A pharmacy participates in a system, which may be run by a claims management service, including a real-time claims processing adjudication component (or real-time processing component), an information component and a claims processing or billing component. When a qualified patient submits a prescription to the participating pharmacy, the pharmacy collects identifying information from the patient and conveys a request containing this information and the prescription to the real-time claims adjudication component. The real-time claims adjudication component screens the request for a match to data already loaded in the system, and, where a match is found, conveys a notification of acceptance to the pharmacy where the prescription is filled and passed onto the patient. Where a match is not found by the screening or a block has been placed on the claim, an error message may be conveyed to the pharmacy. The pharmacy may then contact the information component for further information. The cause of problem may be located and the request may be revised and resubmitted.

The real-time claims adjudication component will compile records of the approved claims and download them to the claims processing or billing component on a periodic basis, such as a daily basis. The claims processing or billing component will process the claims, bill third party payors, and generate periodic (such as daily) files detailing the payments owed to the pharmacy. Reconciliation files may be generated from the payment file and forwarded to the pharmacy. The payment file may be sent to a payment processing component that makes funds available to the pharmacy and notifies the pharmacy of the available funds. The pharmacy may then obtain the funds by initiating a transfer, such as a charge placed on a card issued by the payment processing component. In other embodiments, the real-time processing component may notify and make funds available to the pharmacy. The system and methods may be adapted for use with other insurance plans and third party payors.

### DESCRIPTION OF THE DRAWINGS

It will be appreciated by those of ordinary skill in the art that the various drawings are for illustrative purposes only. The nature of the present invention, as well as other embodiments of the present invention, may be more clearly understood by reference to the following detailed description of the invention, to the appended claims, and to the several drawings.

FIG. 1 depicts a flowchart illustrating the interactions of several components of one illustrative system for providing prescription benefits to a customer with accelerated payment to the pharmacy by a third party payor in accordance with the principles of the present invention.

FIG. 2 depicts a flowchart illustrating one illustrative process for collecting and billing claims made to the system of FIG. 1 in accordance with the principles of the present invention.

FIG. 3 depicts a flowchart illustrating one illustrative embodiment of a process for making payments to pharmacies using the system of FIG. 1 in accordance with the principles of the present invention.

FIG. 4 depicts a flowchart illustrating another illustrative embodiment of a process for making payments to pharmacies using a system in accordance with the principles of the present invention.

### DETAILED DESCRIPTION OF THE ILLUSTRATED EMBODIMENTS

The present invention relates to systems and methods for providing and marketing long-term health care insurance policies that provide prescription benefits to customers with accelerated payment to the pharmacy from a third party payor. It will be appreciated by those skilled in the art that the embodiments herein described, while illustrating certain embodiments, are not intended to so limit the invention or the scope of the appended claims. Those skilled in the art will also understand that various combinations or modifications of the embodiments presented herein can be made without departing from the scope of the invention. For example, it will be appreciated that the methods and systems discussed herein, while particularly suited for providing pharmacy benefits to injured employees covered by worker's compensation policies held by their employers may be easily adapted to provide benefits tied to general health insurance policies or for use in a system including a PBM (prescription benefit manager). The methods for management of the benefits and for providing accelerated payment or claim adjudication services may also be useful in settings in which a provision of other health care services is desired, without the provision of prescription benefits. All such alternate embodiments are within the scope of the present invention.

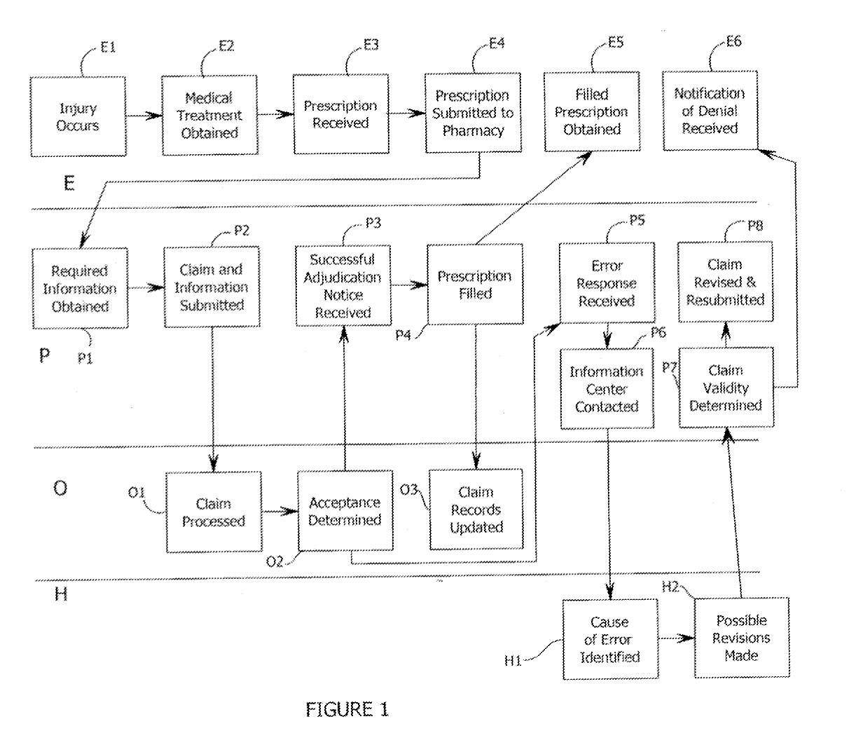

Turning to FIG. 1, a flowchart illustrating the interactions of several components of an illustrative system for providing prescription benefits to a customer with accelerated payment to the pharmacy by a third party payor is depicted. The interactions of a customer E, a pharmacy P, a real-time benefit processing component O, and a help desk or information component H are all depicted. For purposes of clarity, the system will be discussed first on an individual component basis, followed by a discussion of the interactions. In the embodiment shown in FIG. 1, the real-time benefit processing component O, help desk or information component H, and claims processing component C are all provided by a claims management service, such as a claims management company. It will be appreciated that a PBM may serve as a claims management service or may utilize such a service to implement the teachings of the present invention.

In one illustrative embodiment, the customer E may be an employee receiving prescription benefits from a worker's compensation insurance policy held by his employer. One advantage of the illustrative system is that it is not necessary for customer E to keep track of the details of his employer's policy and provide this information to the pharmacy P, nor is it necessary for the customer E to present an insurance card to the pharmacy P. It will be appreciated that the pharmacy P may be a pharmacy system or a chain with multiple locations. For example, a national or regional retail store including pharmacies as a department, or a chain of “drug stores” may participate as a pharmacy P, as well as an independently owned pharmacy.

When customer E is injured on the job, as depicted in box E1, the customer becomes eligible to receive benefits under a worker's compensation policy, including prescription benefits. The customer E receives medical treatment as is appropriate for the injury, for example, by making an emergency room (ER) visit, by going to a physician (as shown in box E2) or visiting another health professional. If necessary and useful for treatment, the customer E receives a prescription for a pharmaceutical product or durable medical good from a health professional, as depicted in box E3.

The customer E then presents the prescription at a pharmacy P, as shown in box E4. The pharmacy P receives the prescription and where the pharmacy is a participant in the system collects information necessary to submit a claim to the claims management service, as shown in box P1. From the perspective of the customer E, either the prescription is filled without a charge to the customer, as shown in box E5, or the customer is informed that the claims management service S has declined to cover the prescription, and the customer E is asked to pay for the prescription, as shown in box E6. Where the customer E is asked to pay for the prescription, the pharmacy P may provide information on submitting a claim for reimbursement from the worker's compensation insurer.

When a pharmacy P that is a participant in the system of the present invention receives and fills a prescription covered by a worker's compensation policy (or other policy utilizing a system in accordance with the present invention), information necessary for real-time claim adjudication is collected from the customer E. Any information necessary for adjudication of the clam may be required; examples of such information may include the name of the patient or employee, the patient's social security number, the name of the employer, the employer's telephone number, the employer's address or other contact information, and the date of the injury. It will be appreciated that this list is merely illustrative and the other information associated with the claim may be collected.

The pharmacy then submits the prescription and the collected information to the real-time benefit processing component O of the system, as shown in box P2 for real-time adjudication of the claim. It is presently preferred that this submission be made electronically, as to an online processing system using a direct network connection, a direct dial modem connection, or over the internet using a secure protocol. The electronic transmission of information may be transmitted in accordance with the standards promulgated under the Health Insurance Portability and Accountability Act (HIPAA) of 1996, which requires U.S.-based health care providers, claims processors and payors to transmit claims and other transactions using a set of common EDI (electronic data interchange) standards. It is preferred that secure network connections and security protocols be used to protect patient identifying information. It will be appreciated that in some embodiments of the system, a dedicated computer terminal may be used to submit the information, or the information may be telephoned into a call center for data entry, all such alternative embodiments are within the scope of the present invention.

The claim submission then undergoes adjudication, as will be discussed further herein. From the perspective of the pharmacy P, either a notice that the claim was accepted is received, as shown in box P3, or an error response is received as indicated in box P5. The notice or error response may be received as a printout from a computer, as a subsequent screen in a webpage-like interface or an email transmitted over a network, or as a telephone call from a call center. Where a notice that the claim was accepted is received, the prescription is filled (as shown in box P4) and given to the patient as shown in box E5.

Where an error response is received, the response may include an indication of the type of error. For example, a typographical error or a failure to provide a necessary item of information in the submission may generate an error response pointing out the deficiency and requesting resubmission. For other errors (or for all errors if desired) the response may simply indicate that an error occurred and instruct the pharmacy P personnel to contact the help desk or information component H of the system. The pharmacy personnel then contacts the help desk or information component H, as depicted in box P6. This contact may be made as is appropriate for the error message. For example, a telephone call may be placed to a call center, or an email may be sent to a support center over a computer network.

The help desk or information center H receives the contact from the pharmacy P and attempts to identify the cause of the error or other reason for the non-approval of the claim submission, as depicted in box H1. If possible, the help desk or information component H will examine the submission and determine if a revision or modification of the submission would result in an approved claim, as depicted in box H2. If so, the help desk or information component H may inform the pharmacy P and instruct the pharmacy to revise and resubmit the submission, as shown in boxes P7 and P8. Such instructions may be provided by personnel at a call center via telephone, or through email or other electronic means. Alternatively, the help desk or information component H may revise and resubmit the claim for the pharmacy P.

Where the help desk or information component H determines that the claim may not be adjudicated to result in coverage by the system, the pharmacy P is so informed, as depicted at box P7. The pharmacy may then provide the prescription to the customer E in exchange for a payment directly from customer E, or may submit the claim to the customer's covering worker's compensation plan, if known.

Turning to the real-time benefit processing component O, the component receives the submissions from the pharmacy, and processes the submissions through an examination system, as shown in box O1. The examination system is typically a computer system operating in accordance with a set of instructions contained in a computer readable code listing, to determine if the claim is accepted, as depicted in box O2. Typically, this process will consist of screening the information collected from the customer E against a database. The contents of the database may consist of information on individuals covered by insurers participating in the system. For example, where a worker's compensation insurer participates in the system, the database may contain identifying information on the employees covered under the plans issued by that insurer. The database may contain information on every covered worker, or only on the workers currently eligible for benefits due to a work-related injury. The database may include all or any desired information on the covered individuals, including the information set forth above as collected by the pharmacy P. The database may be updated on a periodic basis, preferably daily or hourly, although embodiments with weekly or longer updating may be used for certain applications.

In the foregoing embodiment, where a screening of the customer E's information results in match and there is not a block placed on that customer E or accounts associated with his insurer or employer (as applicable), the claim is accepted. Where no match is found, or a block has been placed in the system, the claim will not be accepted.

If the examination process indicates claim acceptance, the real-time benefit processing component O conveys a successful adjudication notice to the pharmacy P, as shown in box P3 and updates the claim records maintained for that pharmacy, as shown in box O3. If the claim is not accepted, an error response is conveyed to the pharmacy, as depicted in box P5. As discussed previously herein, the successful adjudication notice or error message may be conveyed by the real-time benefit processing component O to the pharmacy P by any suitable means, for example a webpage-like interface may be generated over a network connection following entry of the data in a similar webpage-like interface, an email or other electronic message or a facsimile may be generated. Alternatively, a phone call may be placed by an automated telephone dialing device, or by personnel employed at the real-time benefit processing component O. In some embodiments, an error message may be conveyed by the real-time benefit processing component O to the help desk or information component H, which will then contact the pharmacy P to begin the help desk or information component H processes.

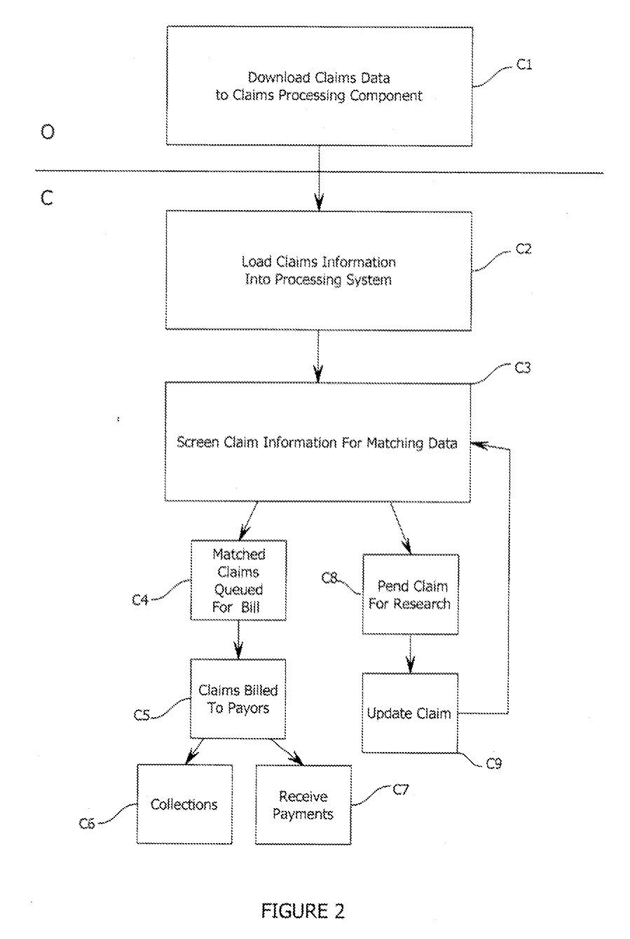

Turning to FIG. 2, one illustrative flowchart of a process for collecting and billing claims made to the system of FIG. 1 is depicted. Interactions between the real-time benefit processing component O, discussed in connection with FIG. 1, and a claims processing component C are depicted. It will be appreciated that as with the embodiment shown in FIG. 1, the claims processing component C may be provided by a claims management service, such as a claims management company providing the real-time benefit processing component O, and help desk or information component H.

On a periodic basis, such as hourly, daily or weekly, the real-time benefit processing component O downloads the updated claim records for the previous period to the claims processing component C, as depicted in box C1, where the claims are loaded into a claims processing system, as depicted in box C2. The data for the downloaded claims is screened for a match with claims data from the responsible payors that is already loaded in the system, as shown in box C3. Where a match is found, the claim is queued to be placed in a daily bill, as shown in box C4, a bill is generated and forwarded to the responsible payor (such as a worker's compensation insurance company, a self-insured employer, or other insurance company or payor, as shown in box C5. The bill may be generated and forwarded in any suitable manner, and as is typically preferred by the payor. For example, a bill may be printed and mailed, may be transmitted as data over a network in a proprietary format, may be transmitted as a HIPAA (Health Insurance Portability an Accountability Act) complaint EDI transmission, or otherwise sent. A depositing and posting process for handling amounts paid by the payors to the system is conducted, as depicted in box C6. Where necessary, a collections process may be initiated following a suitable time after the transmission of the bill, as shown in box C7. The depositing and posting process and collections process may be conducted in any suitable fashion known to those of ordinary skill in the art.

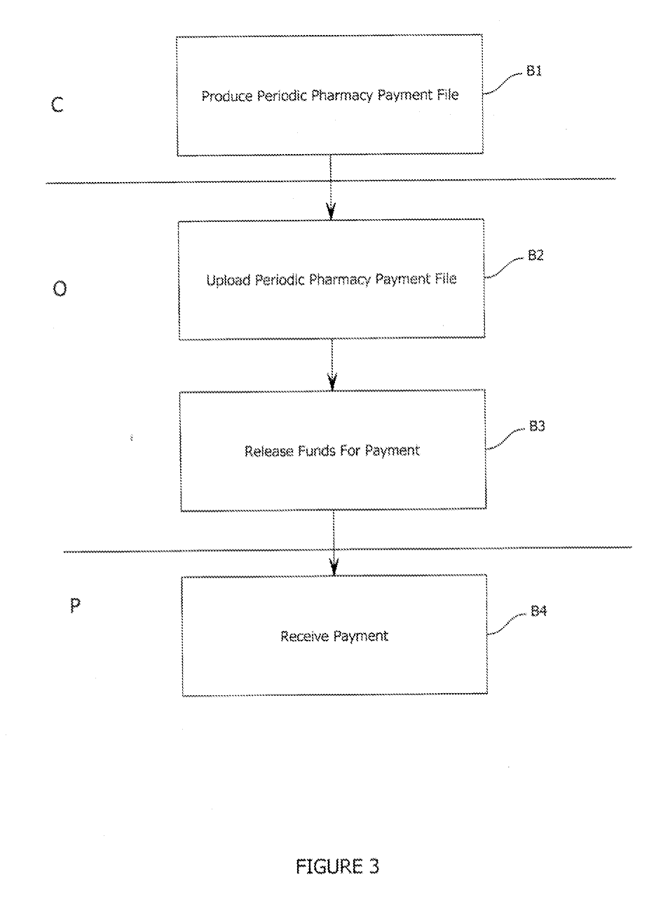

FIG. 3 depicts an illustrative embodiment of a process for making payments to pharmacies using the system of FIG. 1. Interactions between the claims processing component C, the real-time benefit processing component O, and the pharmacy discussed in connection with FIGS. 1 and 2 are depicted. It will be appreciated that as with the embodiments shown in FIGS. 1 and 2, the claims processing component C, the real-time benefit processing component O, and the help desk or information component H may be provided by a claims management service, such as a claims management company.

As shown in box B1, the claims processing component C produces a periodic pharmacy payment file, which may be produced on a monthly, bi-monthly, weekly, daily, or other desired basis. This file may be compiled from the claims loaded into the claims processing system, as discussed in connection with FIG. 2. As depicted in box B2, this periodic pharmacy payment file is uploaded by the real-time benefit processing component O, which then releases the funds specified in the payment file for payment to the pharmacy P, as shown in box B3.

On a periodic basis, preferably corresponding to the periodic production of the pharmacy payment file by the claims processing component C, the pharmacy P will receive a guaranteed payment for the claims that have been approved by the real-time benefit processing component O, as depicted in box B4. In one illustrative embodiment, each participating pharmacy is issued a credit card, charge card, or debit card by a claim management service that is associated with an account maintained by the claims management service. At the periodic intervals, the pharmacy P may receive a notification from the claims management service, as from the real-time benefit processing component O, that the claims submitted in a designated period are ready for payment. This notification may contain the total amount to be paid to the pharmacy P for such claims. The pharmacy personnel P may then place a charge on the issued card (such as a VISA, MASTERCARD, DINERS, AMERICAN EXPRESS, DISCOVER, or other charge card, credit card or debit card) for the approved amount, which is then credited to an account associated with the pharmacy P.

In an illustrative charge card embodiment, it will be appreciated that the periodic charge may be placed using the charge card network provided by the card issuer, as with any other charge card transactions made at the pharmacy P. It will be appreciated that the card issuer may only authorize charges for an amount up to the amount released by the real-time benefit processing component O for payment to the pharmacy. Any attempt to charge additional amounts may be denied. Similarly, any attempt to charge an amount less than that released, and sent by notification to the pharmacy may be declined. The release of funds may similarly require that the charge be placed within a required time window, such as twenty-four or forty-eight hours from the release of funds and dispatch of the notification.

It will be appreciated that rather than require the pharmacy P to place a charge for a specific amount that corresponds to the claims approved by the real-time benefit processing component O for that time period, that an estimated amount or a rolling average may be made available for the pharmacy P. For example, where the pharmacy submits a consistent level of approved claims over an extended time period, the weekly average for approved claims may be made available to that pharmacy at a specific time each week. On a periodic basis, the average may be adjusted and any deviations from the average “caught up” with a supplementary payment or by increasing or reducing the average payment, as appropriate.

It will be appreciated that the charge card may be a purchase card, or “P card,” which is used to access an account belonging to a claims management service, such as a claims management company. There are known P cards which are issued to card holders that allow access to a subaccount under a general account belonging to another. For example, an employee responsible for making routine purchases on behalf of his employer may be issued a P card allowing charges to be placed in an amount sufficient to cover those routine purchases to be made from subaccount under the employer's general account. In a similar manner, the charge card issued to the pharmacy P may allow access to a subaccount under a general account associated with the claims management service. Such a card may include a magnetic stripe, an embedded microchip or other data storage and computer readable media for allowing access via a computer network.

The guaranteed payment for the claims that have been approved by the real-time benefit processing component may be provided to the pharmacy P from a credit line associated with the claims management service, as by a bank credit line provided to the claims management service by a bank or other financial institution. For example, the payment may be made by allowing a charge to the placed on the credit line by the pharmacy P, as a charge placed on a charge card, in such an embodiment, the credit line may be a credit card account on which the card is issued as a subaccount. Alternatively, the claims management service may make periodic wire transfers to a bank account associated with the pharmacy from a credit line. Currently, claims management services wait until payment for adjudicated claims is received from the insurer to make payments to pharmacies, resulting in delayed payment to the pharmacy. By using a credit line, payment may be made to the pharmacies on an accelerated basis, such as weekly or even daily. The claims management service may then bill the insurer, as explained previously herein, and receive payment therefrom. The amounts utilized by the claims management service on the credit line may then be paid to the credit provider. As such credit lines are typically billed on a monthly basis, this may be accomplished without appreciable extra expense to the claims management service, once the credit line is established.

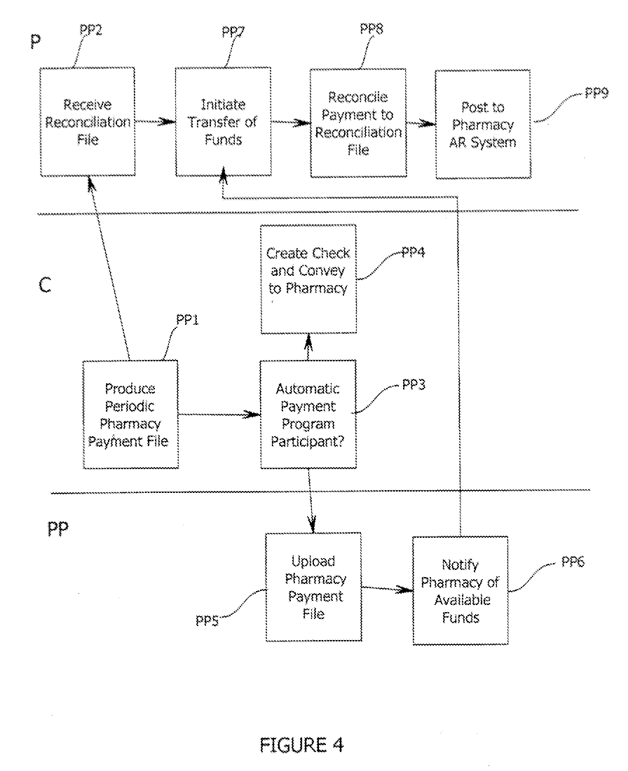

FIG. 4 depicts another illustrative embodiment of a process for making payments to pharmacies using a system of the present invention. Interactions between a claims processing component C, a pharmacy P (which may be as discussed in connection with FIGS. 1 and 2) and a payment processing component PP are depicted. It will be appreciated that the claims processing component C and the payment processing component PP may be provided by a claims management service, such as a claims management company.

As shown in box PP1, the claims processing component C produces a periodic pharmacy payment file, which may be produced on a monthly, bi-monthly, weekly, daily, or other desired basis. This file may be compiled from the claims loaded into the claims processing system, as discussed in connection with FIG. 2, and is typically specific for a pharmacy P. As depicted in box PP2, the pharmacy P may then receive a reconciliation file from the claims processing component C. This may be an EDI file transmitted to the pharmacy P, or may be paper file generated as one or more documents that may be conveyed to the pharmacy P. Where pharmacy P includes a pharmacy system or chain, the reconciliation file may be conveyed to individual locations and include the information for that location, or may be conveyed to an accounting department for multiple locations and include information on the claims for all relevant locations.

As shown in box PP3, the periodic pharmacy payment file is then routed depending on the payment arrangement with the participating pharmacy P. Where the pharmacy P is not a participant in an automatic payment program, the file is routed to a billing system in claims processing for the creation of a payment check, which may then be conveyed to the pharmacy P as shown in box PP4. Where the pharmacy is a participant in an automatic payment program, the periodic pharmacy payment file is uploaded by a payment processing component PP, as shown in box PP5. The payment processing component PP then notifies the pharmacy P that the funds specified in the payment file for payment to the pharmacy P are available, as shown in box PP6. As discussed previously herein, such notification may be made by EDI interchange, email, telephone call, facsimile, or as is otherwise desired.

Upon receiving the notification, the pharmacy P may initiate the transfer of funds as payment for the claims that have been approved by the real-time benefit processing component O, as depicted in box PP7. As discussed previously herein, in some illustrative embodiments, each participating pharmacy may place a charge on a credit card, charge card, or debit card issued to it by a claim management service, for the approved amount contained in the notification, which is then credited to an account associated with the pharmacy P. It will be appreciated that the card may be a purchase card, “P card” or other credit account which is used to access an account belonging to a claims management service, such as a claims management company. As with the embodiment of FIG. 3, it is possible for payment to be made on a monthly, weekly or even daily basis, accelerating the payment to the pharmacy P from the standard 45 days typically required to collect payment from a worker's compensation plan or other insurer.

As discussed previously herein, it will be appreciated that the charge may be placed using the charge card network provided by the card issuer, as with any other charge card transactions made at the pharmacy P. It will be appreciated that the card issuer may only authorize charges for an amount up to the amount released by the payment processing component PP for payment to the pharmacy. Any attempt to charge additional amounts may be denied. Similarly, any attempt to charge an amount less than that released, and sent by notification to the pharmacy may be declined. Such restrictions on the amount charged, while not necessarily required, can help the claims management service to more easily reconcile amounts released with amounts withdrawn by the pharmacy P. The release of funds may similarly require that the charge be placed within a required time window, such as twenty-four or forty-eight hours from the release of funds and dispatch of the notification. As also discussed in connection with FIG. 3, the payment may be made by wire transfer or bank transfer, or by utilizing a credit line, as may be appropriate and desirable for the specific implementation.

As depicted in box PP8, the pharmacy P may reconcile the payment received to the reconciliation file provided from the claims processing component C, as well as to the pharmacy's own records of requests submitted to the real-time benefit processing component O. Upon reconciliation, the payment and claims may be posted to the accounts receivable for the pharmacy P, as depicted in box PP9. In this fashion, the system and methods of the present invention may allow for faster accounting and better record-keeping for the participating pharmacies.

Using the systems and methods discussed in connection with FIGS. 1 through 4, it will be apparent to one of skill in the art that the present invention may be used to accelerate payment of the claims to pharmacies to much shorter time frame, using a monthly, weekly, or even daily periodic report and release of funds from a claims management service, such as a claims management company, which then collects from the third-party payors. Typically, the participating pharmacies will either agree to payment on a schedule negotiated with the claims management service, or to pay a transaction fee for each claim submitted to the service, thus either taking a slightly lower payment or incurring a charge for each prescription filled through the system, in exchange for a guaranteed payment for each accepted claim on an expedited basis.

While this invention has been described in certain embodiments, the present invention can be further modified with the spirit and scope of this disclosure. This application is therefore intended to cover any variations, uses, or adaptations of the invention using its general principles. Further, this application is intended to cover such departures from the present disclosure as come within known or customary practices in the art to which this invention pertains and which fall within the limits of the appended claims.

What is claimed is:

1. A method for accelerated payment of prescription benefits to a pharmacy, the method comprising:
receiving identifying information of a patient from a pharmacy;
adjudicating a request for prescription benefit coverage based on the identifying information;
conveying a notification to the pharmacy that the request for prescription benefit coverage is approved;
conveying a notification to the pharmacy that funds are available as payment for the prescription benefit coverage; and
providing a guaranteed payment for the prescription benefit coverage to the pharmacy by approving a charge to be placed on a charge card provided to the pharmacy by a claims management service.

2. The method according to claim 1, wherein receiving identifying information of a patient from a pharmacy comprises receiving identifying information for a patient eligible for worker's compensation coverage.

3. The method according to claim 1, wherein receiving identifying information of a patient from a pharmacy comprises receiving identifying information selected from the group consisting of a name of the patient, the patient's social security number, a name of the patient's employer, a telephone number, an employer's address, and the date of the injury for which the prescription is intended.

4. The method according to claim 1, wherein conveying a notification to the pharmacy that the request for prescription benefit coverage is approved comprises conveying a notification over a computer network.

5. The method according to claim 1, wherein conveying a notification to the pharmacy that funds are available as payment for the prescription benefit coverage comprises conveying a notification to the pharmacy that funds are available as payment for a number of prescriptions approved during a set time period.

6. The method according to claim 5, further comprising conveying a reconciliation file to the pharmacy, detailing the prescriptions for which the funds are available as payment.

7. The method according to claim 1, further comprising producing a periodic pharmacy payment file from the notification to the pharmacy that the request for prescription benefit coverage is approved.

8. The method according to claim 7, wherein the periodic pharmacy payment file is produced on a weekly basis.

9. The method according to claim 1, wherein providing a guaranteed payment for the prescription benefit coverage to the pharmacy by approving a charge to be placed on a charge card provided to the pharmacy by a claims management service comprises approving a charge for an amount specified in the notification that funds are available to be placed on a charge card.

10. The method according to claim 1, wherein providing a guaranteed payment for the prescription benefit coverage to the pharmacy by approving a charge to be placed on a charge card provided to the pharmacy by a claims management service comprises placing a charge on a charge card selected from the group consisting of a P card, a debit card, a credit card and a charge card.

11. The method according to claim 1, wherein providing a guaranteed payment for the prescription benefit coverage to the pharmacy by approving a charge to be placed on a charge card provided to the pharmacy by a claims management service comprises approving a charge that is placed on an account associated with the claims management service.

12. The method according to claim 11, wherein approving a charge that is placed on an account associated with the claims management service comprises approving a charge to be placed on a line of credit for which the claims management service is responsible.

13. The method according to claim 1, further comprising conveying a notification to the pharmacy that there is an error in the request for prescription benefit coverage following adjudicating the request for prescription benefit coverage based on the identifying information.

14. The method according to claim 13, further comprising assisting the pharmacy to revise the identifying information of a patient and receiving the revised identifying information of a patient.

15. A system for providing accelerated payment of prescription benefits to a pharmacy, the system comprising:
a real-time processing component for receiving a request for prescription benefits from a pharmacy, the real-time processing component configured to compare information collected from a patient to a database and to accept the request if a match is located and convey the acceptance to the pharmacy before a filled prescription is provided to the patient;
a claims processing component for downloading accepted requests from the real-time processing component and generate a bill to a third-party payor for the accepted request and to generate a periodic pharmacy payment file from the processed accepted requests; and
a payment processing component for releasing funds from a credit line to the pharmacy on a periodic basis in response to the periodic pharmacy payment file.

16. The system of claim 15, wherein the real-time processing component is configured to receive the periodic pharmacy payment file and to function as the payment processing component by releasing the funds to the pharmacy.

17. The system of claim 15, wherein the payment processing component is configured to convey a notification to the pharmacy that funds are available for payment.

18. The system of claim 17, wherein the payment processing component releases funds from a credit line to the pharmacy by making a charge available on a card issued to the pharmacy, the card selected from the group consisting of a P card, a debit card, a credit card and a charge card.

19. The system of claim 15, wherein the claims processing component is configured to release a reconciliation file detailing the accepted requests taken from the periodic pharmacy payment file to the pharmacy.

20. The system of claim 15, further comprising a help desk or information component for assisting the pharmacy in correcting an error in a request for benefits, if the request is refused by the real-time processing component.
